(19) United States
(12) Patent Application Publication
(10) Pub. No.: US 2020/0291275 A1
(43) Pub. Date: Sep. 17, 2020

(54) METHOD FOR MANUFACTURING NON-TRANSPARENT ADHESIVE AND THE PRODUCT THEREOF

(71) Applicants: Interface Technology (ChengDu) Co., Ltd., Chengdu City (CN); Interface Optoelectronics (ShenZhen) Co., Ltd., Shenzhen City (CN); General Interface Solution Limited, Zhunan Township (TW)

(72) Inventors: YU-CHIEH TU, Zhunan Township (TW); SHENG-CHUN CHUANG, Zhunan Township (TW)

(21) Appl. No.: 16/383,352

(22) Filed: Apr. 12, 2019

(30) Foreign Application Priority Data
Mar. 15, 2019 (CN) 201910197223.4

(51) Int. Cl. C09J 11/04; C09J 133/12

(52) U.S. Cl. CPC C09J 11/04; C08K 3/22; C09J 2203/326; C09J 133/12

(57) ABSTRACT

A method for preparing an opaque adhesive comprising adding a titanium dioxide nanoparticle or a quantum dot to a matrix of a binder. The titanium dioxide nanoparticle is spherical or rod-shaped. The process exhibits superior thermal and chemical stability. The non-transparent adhesive incorporates TiO₂ nanoparticles or a quantum dots into an adhesive matrix to form a chromatic composite adhesive, wherein the TiO₂ nanoparticle is rod-shape or sphere-shape.

### BACKGROUND OF THE INVENTION

### Field of the Invention

The present invention relates to the field of adhesives. More particularly, the present invention discloses an opaque adhesive and a method of manufacturing the opaque adhesive.

### Description of the Prior Art

Numerous studies on nanoparticles have been undertaken in academia and industry. It has been found that physicochemical properties of many binders can be adjusted by the addition of inorganic nanoparticles.

One technique involves the preparation of a cerium oxide/PMMA hybrid material with high transparency and stability by a sol-gel process. Also, it has been shown that the incorporation of cerium oxide nanoparticles and diamond particles into a UV-cured polyacrylate coating improves the scratch and abrasion resistance of the coating. Additionally, surface functionalized alumina nanoparticle-filled polymer nanocomposites can exhibit enhanced mechanical properties. Further, titanium dioxide in the pigment grade form utilizes the excellent light scattering properties of titanium dioxide in applications requiring white opacity and brightness.

Research on the size-dependent optical properties of colloidal semiconductor quantum dots has received increased attention due to the use of colloidal semiconductor quantum dots in light-stable luminescent biotags and LEDs. Colloidal semiconductor quantum dots are typically uniformly dispersed in a transparent film or liquid binder.

### SUMMARY OF THE INVENTION

The present invention provides a color composite adhesive and a method of preparation for the adhesive. The size and degree of mixing is observed utilizing a strain relief (SR)/nanoparticle composite binder through an optical microscopy instrument (Optical Microscope, OM). The present invention utilizes the synthesis of different CdSe quantum dots with different photoluminescence and different TiO₂, and then incorporates CdSe quantum dots or titanium dioxide nanoparticles into the binder matrix to form various color composite binders.

The present invention also provides a method for preparing a colored composite adhesive comprising adding 0.001 to 5 wt. % of titanium oxide (TiO₂) or 0.001 to 5 wt. % of CdSe quantum dots to an adhesive matrix to prepare different colors of adhesive.

The invention further provides a composite adhesive prepared by the method of the invention.

The present invention discloses surface-modified titanium dioxide nanoparticles which are dispersed in the binder. Different types of surface modified titanium dioxide nanoparticles are incorporated into the binder matrix to form a hybrid composite binder. Hybrid composite adhesives have a higher storage module than a pure adhesive system. The storage module can be adjusted by using different forms of titanium dioxide nanoparticles and by changing the solids content of the titanium dioxide. In addition to enhancing the storage module, the present invention also blends the color of the composite adhesive from a transparent hue to a light white color.

Furthermore, different sizes of trioctylphosphine oxide (TOPO) modified CdSe quantum dots may further be incorporated into the adhesive matrix to form a color composite binder. Therefore, the size of the color composite adhesive can be observed through the OM.

Additionally, mixed SR/nanoparticle composite adhesives generally have better thermal and chemical stability than SR/dye composite adhesives.

### BRIEF DESCRIPTION OF THE DRAWINGS

FIG. 1 is a cross sectional view of the mixing strain relief (SR) assigned gap region filled in a printed circuit board/binder of composite nanoparticles;

FIG. 2 (a) is an illustration of nano-TiO₂ particles of a TEM image;

FIG. 2 (b) is an illustration of nano-TiO₂ particles of a high-resolution TEM image;

FIG. 3 is a TEM image of rod-shaped TiO₂ nanoparticles;

FIG. 4 (a) is a chemical structure diagram of an N3 dye;

FIG. 4 (b) is a chemical structure diagram of a W4 dye; and

FIG. 5 (a)-5 (c) are illustrations of structures of various TiO₂ particles, (a) spherical TiO₂ particles, (b) rod-shaped TiO₂ particles, (c) another spherical TiO₂ particles, wherein X is oleic acid, and Y A pigment derived from N3 or W4.

### DESCRIPTION OF THE PREFERRED EMBODIMENTS

The following examples are further described in detail, but the present examples are not intended to limit the present invention, and all similar structures and similar modifications of the present invention should be included in the scope of the present invention.

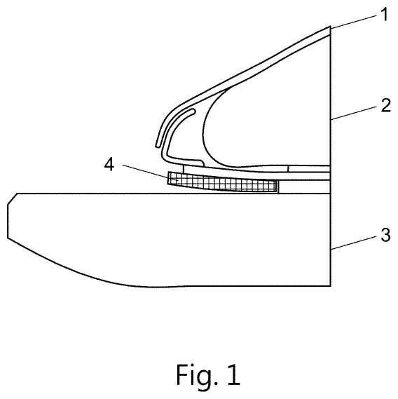

FIG. 1 illustrates an elastic printed circuit 1, a metal frame 2, a printed circuit board 3, and a mixing SR/Nano Particle Composite Adhesive 4.

In an embodiment, titanium dioxide nanoparticles having an oleic acid agent, including spherical TiO₂ nanoparticles and rod-shaped TiO₂ nanoparticles, are synthesized by a sol-gel technique, and then the nanoparticles are fused into the binder. The matrix forms an opaque adhesive composition.

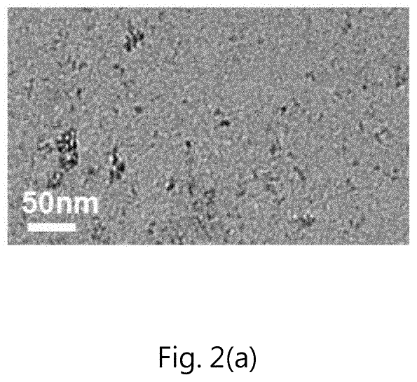

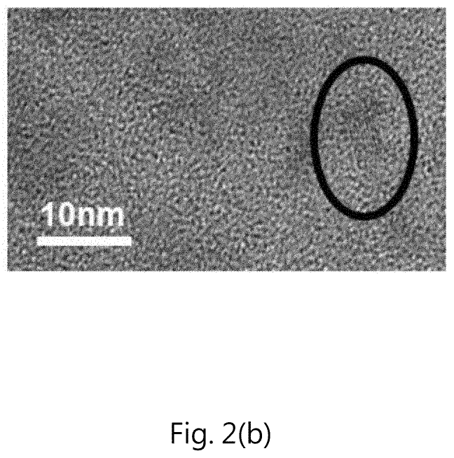

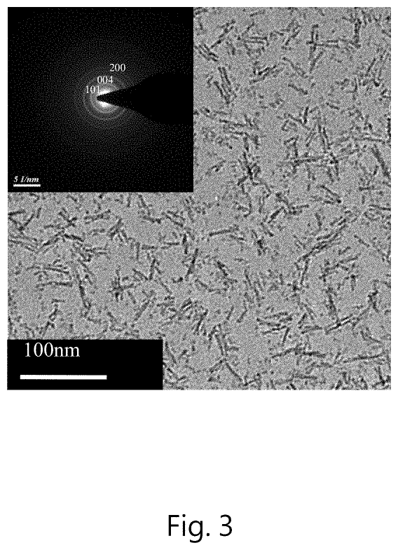

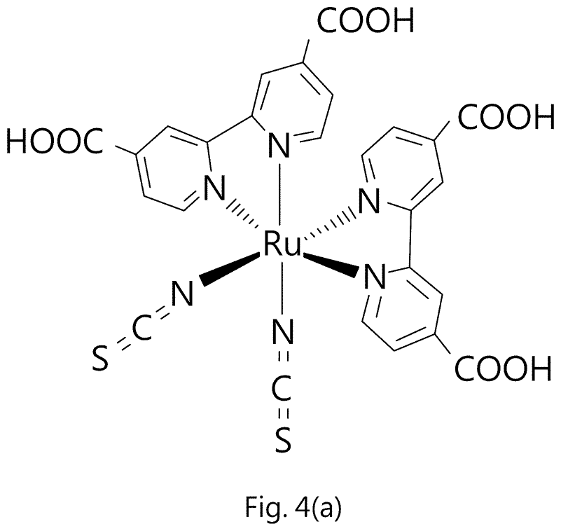

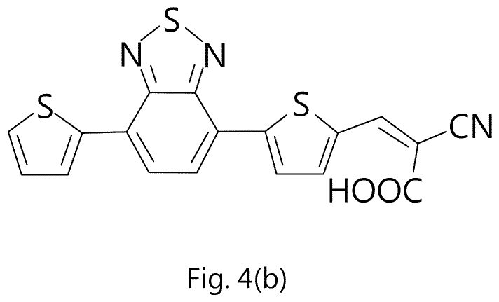

The precursor of TiO₂ is titanium isopropoxide and the surfactant is oleic acid. The present invention uses different amounts of trimethylamine N-oxide dehydrate (trimethylamine N-oxide dehydrate, TMAO) as a catalyst to synthesize nano TiO₂ spherical particles (excluding TMAO, FIGS. 2 (a) and 2 (b) and rod-shaped TiO₂ (including TMAO, as shown in FIG. 3). The synthesized TiO₂ nanoparticles are then modified by small molecules (such as an N3 dye and W4 dye shown in FIG. 4) to partially remove the insulating surface ligand oleic acid.

Further, 0.001 to 5 wt. % of titanium dioxide (TiO₂) is added to the binder matrix to prepare binders of different colors.

The precursor of TiO₂ comprises, but is not limited to, titanium tetrakisisopropoxide, Tetra-n-butyl Titanate, titanium chloride, or titanium butoxide.

In other embodiments, titanium dioxide nanoparticles is prepared using a titanium tetrachloride neutralization hydrolysis process, a titanium sulfate hydrolysis process, or a high temperature hydrolysis process, hydrothermal synthesis process.

In the method, Cadmium oxide (CdO), tetradecylphosphonic acid mixture (TDPA) and trioctylphosphine oxide (TOPO) are heated to 300 degrees C. under argon, and are converted into a phase solution synthesis of CdSe nanocrystals. After the introduction of a selenium and trioctylphosphine (TOP) solution, the reaction is allowed to react for a few minutes and cooled to room temperature. The synthetic size of CdSe can be adjusted by controlling the reaction time.

0.001 to 5 wt. % of CdSe quantum dots is added to the binder matrix to prepare binders of different colors.

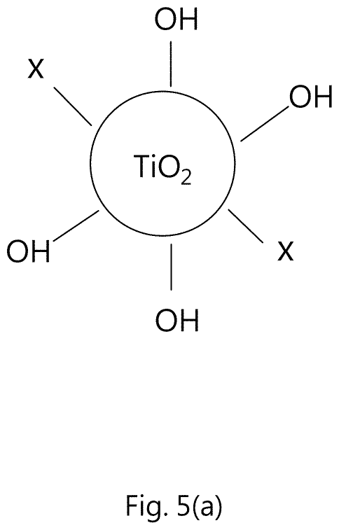

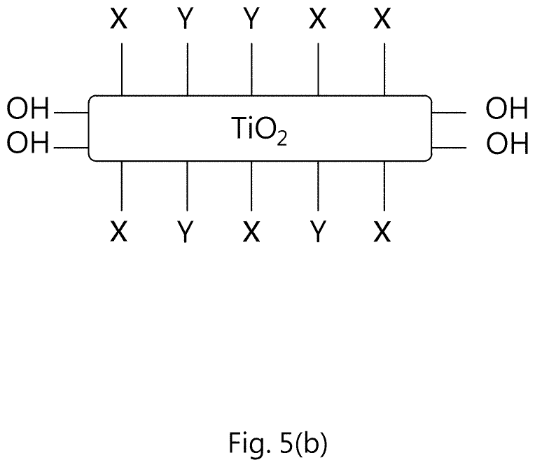

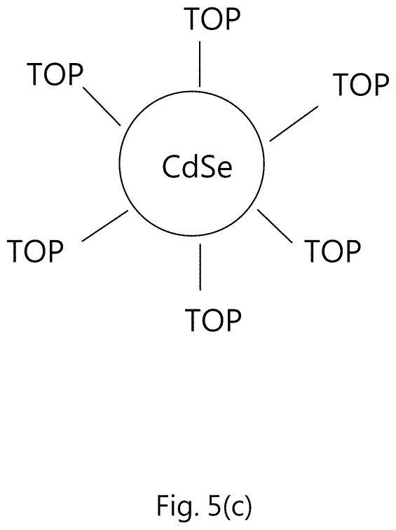

Preferably, the present invention synthesizes TiO₂ nanoparticles and CdSe nanoparticles (as shown in FIG. 5) using wet chemical methods. In FIG. 5, X denotes oleic acid and Y denotes a derived pigment

In an embodiment, the adhesive matrix material comprises an acrylate type transparent adhesive having the composition shown in Table 1 below:

TABLE 1
acrylate adhesive components

| Composition | Wt. % | Note |
|---|---|---|
| Acrylate | 49 | Reactive monomer |
| 2,2-dimethoxy-2-phenylacetophenone | 10 | CAS No. 24650428 |
| N,N-dimethylacrylamide | 20 | CAS No. 2680037 |
| Silane couple agent | 10 | N/A |
| Diphenyl(2,4,6- | 10 | CAS No. 75980608 |
| trimethylbenzoyl)phosphine oxide | | |
| 2-Hydroxyethyl acrylate | <1 | CAS No. 818611 |

It is to be understood that the above described embodiments of the present invention are only examples, and are not intended to limit the scope, applicability, or configuration of the invention in any manner. Various changes in the function and arrangement of the elements can be made without departing from the scope of the invention and the legal equivalents thereof

What is claimed is:

1. A method of preparing an opaque hybrid composite adhesive comprising adding titanium dioxide nanoparticles or quantum dot nanoparticles to a binder matrix.

2. The method of claim 1, wherein the titanium dioxide nanoparticle or quantum dot nanoparticle has a weight percentage of 0.001 to 5 wt. %.

3. The method of claim 1, wherein the titanium dioxide nanoparticles are rod-shaped or spherical.

4. The method of claim 1, wherein the quantum dot is a cadmium selenide quantum dot.

5. The method of claim 1, wherein the titanium dioxide nanoparticles are prepared in a sol gel.

6. The method of claim 1, wherein a surface of the titanium dioxide nanoparticle has a modification of a derivative pigment.

7. An opaque hybrid composite adhesive comprising a binder matrix and titanium dioxide nanoparticles or quantum dot nanoparticles added to the binder matrix.
